(19) United States
(12) Patent Application Publication
(10) Pub. No.: US 2009/0190629 A1
(43) Pub. Date: Jul. 30, 2009

(54) Temperature Sensing Device for Improving Series Resistance Cancellation Mechanism

(76) Inventors: Chun-Chieh Fang, Tainan County (TW); Chih-Yung Tsau, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/126,993

(22) Filed: May 26, 2008

(30) Foreign Application Priority Data
Jan. 25, 2008 (TW) 097102809

(51) Int. Cl. G01K 7/16

(52) U.S. Cl. 374/185; 374/E07.018

(57) ABSTRACT

A temperature sensing device for improving series resistance cancellation mechanism includes a temperature sensing unit, a signal processing unit, a first current source, a second current source, a third current source, a first switch, a second switch, and a third switch. A control circuit generates a first control signal, a second control signal and a third control signal for controlling the first current source, the second current source and the third current source so as to drive the temperature sensing unit, wherein the first control signal, the second control signal and the third control signal are outputted from the control circuit according to a specific cycle formed by a plurality of switches between the first control signal and the second control signal and a switch between the first control signal and the third control signal.

### BACKGROUND OF THE INVENTION

1. Field of the Invention

The present invention relates to a temperature sensing device, and more particularly, to a temperature sensing device for improving series resistance cancellation mechanism.

2. Description of the Prior Art

A temperature sensing circuit is widely used in kinds of electronic equipments, such as consumer electronic products, power equipments and industrial instruments, for measuring temperature for the purpose of protection or efficiency enhancement. For a personal computer, a temperature sensing device can help heat dissipation of a power management system of the personal computer, so as to ensure that the personal computer operates in a safety temperature range.

Please refer FIG. 1. FIG. 1 is a schematic diagram of a temperature sensing device 10 according to the prior art. The temperature sensing device 10 comprises a temperature sensing unit 100, a signal processing unit 102, current sources 104 and 106, and switches 108 and 110. The temperature sensing unit 100 comprises a temperature sensing component 120 and resistors R_{B} and R_{E}. The signal processing unit 102 is coupled to the resistors R_{B} and R_{E}, that is, the signal processing unit 102 is coupled to the two terminals of the temperature sensing unit 100. The signal processing unit 102 is utilized for generating an output voltage signal Vₒᵤₜ for presenting temperature variation according to a difference ΔV_{BE} between two voltage differences of the two terminals of the temperature sensing unit 100 at different currents. The switch 108 is coupled between the current source 104 and the signal processing unit 102; the switch 110 is coupled between the current source 106 and the signal processing unit 102. A control circuit 12 is utilized for generating control signals for controlling ON/OFF states of the switches 108 and 110 so as to control the current sources 104 and 106 to drive the temperature sensing unit 100.

The temperature sensing unit 100 will be described in detail as follows. In the prior art temperature sensing device 10, the temperature sensing component 120 is usually not located at the place beside the signal processing unit 102, therefore, the line of the current path between the temperature sensing component 120 and the signal processing unit 102 is equivalent to a series resistor. On the other hand, the temperature sensing component 120 is a non-ideal component with parasitic resistors inside. In FIG. 1, the temperature sensing component 120 is a PNP bipolar junction transistor (BJT), wherein the resistors R_{B} and R_{E} are regarded as the sum of the parasitic resistors of the temperature sensing component 120 and the series resistors in the lines forming the current path between the temperature sensing component 120 and the signal processing unit 102. In FIG. 1, I_{C1} and I_{C2} respectively represent output currents of the current sources 104 and 106; ΔV_{BE} is the difference between two voltage differences of the two terminals of the temperature sensing unit 100 at different currents, I_{C1} and I_{C2}, when the current sources 104 and 106 are switched. Let I_{C2}=N×I_{C1}, so that V_{BE1}/V_{BE2} is the voltage difference between the two terminals of the temperature sensing unit 100 when the current source 104/106 drives the temperature sensing unit 100; V_{T} is temperature equivalent voltage; Iₛ is a saturation current of the temperature sensing component 120; β is a characteristic parameter of the temperature sensing component 120; rₑ is the resistance of the resistor R_{E}; r_{b} is the resistance of the resistor R_{B}. According to the series resistor effect, V_{BE1}, V_{BE2} and ΔV_{BE} are given by the following equations:

V_{BE1}=V_{T}×In(I_{c1}/Iₛ)+I_{c1}×rₑ+I_{c1}/(β+1)×r_{b}

V_{BE2}=V_{T}×In(I_{c2}/Iₛ)+I_{c2}>rₑ+I_{c2}/(β+1)×r_{b}

ΔV_{BE}=V_{BE2}−V_{BE1}=V_{T}×In(N)+(N−1)×I×(rₑ+1/ (β+1)×r_{b}) (1)

From the equation (1), it is known that the series resistor effect can be cancelled when N=1, that is, I_{C1}=I_{C2}. However, when N=1, ΔV_{BE}=V_{T}×In(1)=0. In other words, ΔV_{BE} is always independent of the environment temperature variation of the temperature sensing component 120. As a result, the temperature sensing device 10 cannot get multiple of ΔV_{BE} by switching the current sources 104 and 106, thereby the accuracy of temperature sensing cannot be improved.

In conclusion, in the prior art temperature sensing device, the effect of current path series resistors and parasitic resistors cannot be cancelled. For improving the accuracy of temperature sensing, there should be a better way to cancel the series resistor effect.

### SUMMARY OF THE INVENTION

It is therefore a primary objective of the claimed invention to provide a temperature sensing device for improving series resistance cancellation.

The present invention discloses a temperature sensing device for improving series resistance cancellation, which includes a temperature sensing unit including a first terminal and a second terminal for generating a plurality of voltage signals, a signal processing unit coupled to the temperature sensing unit for performing a signal process on the plurality of voltage signals for generating an output signal for presenting temperature variation, a first current source for driving the temperature sensing unit, a second current source for driving the temperature sensing unit, a third current source for driving the temperature sensing unit, a first switch coupled between the first current source and the first terminal of the temperature sensing unit for controlling a signal connection between the first current source and the first terminal of the temperature sensing unit according to a first control signal, a second switch coupled between the second current source and the first terminal of the temperature sensing unit for controlling a signal connection between the second current source and the first terminal of the temperature sensing unit according to a second control signal, and a third switch coupled between the third current source and the first terminal of the temperature sensing unit for controlling a signal connection between the third current source and the first terminal of the temperature sensing unit according to a third control signal, wherein the first control signal, the second control signal and the third control signal are generated by a control circuit and are outputted from the control circuit according to a specific cycle formed by a plurality of switches between the first control signal and the second control signal and one switch between the first control signal and the third control signal.

The present invention further discloses a temperature sensing device for improving series resistance cancellation, which includes a temperature sensing unit including a first terminal and a second terminal for generating a plurality of voltage signals, a signal processing unit coupled to the temperature sensing unit for performing a signal process on the plurality of voltage signals for generating an output signal for presenting temperature variation, a plurality of current sources for driving the temperature sensing unit, and a plurality of switches, each of the plurality of switches being coupled between a corresponding current source of the plurality of current sources and the first terminal of the temperature sensing unit for controlling a signal connection between the corresponding current source of the plurality of current sources and the first terminal of the temperature sensing unit according to one of a plurality of control signals, wherein a number N of the plurality of current sources is greater than or equal to 3 and the plurality of control signals are generated by a control circuit and are outputted from the control circuit according to a specific cycle formed by an output order of a first control signal, a Nth control signal, a second control signal, the Nth control signal, a third control signal, the Nth control signal, . . . , a (N−1)th control signal and the Nth control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a temperature sensing device according to the prior art.

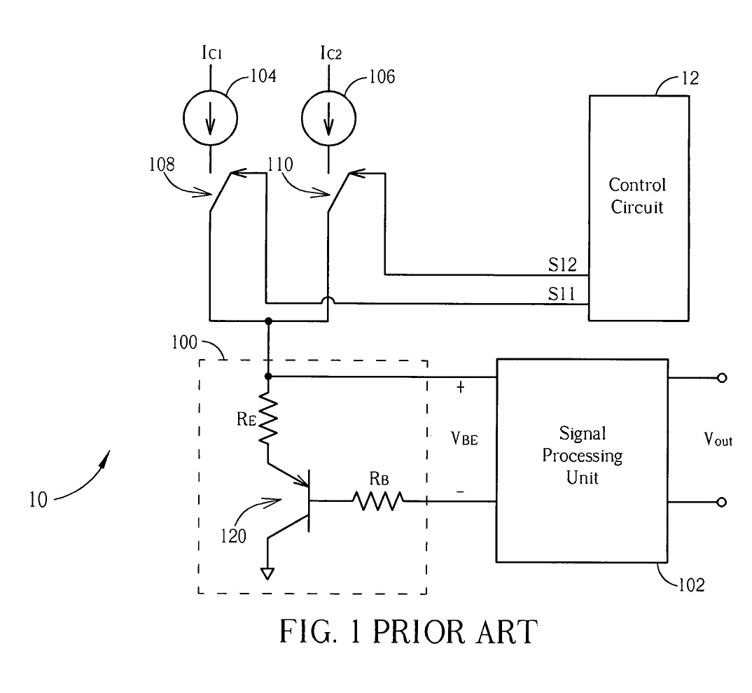

FIG. 2 is a schematic diagram of a temperature sensing device according to an embodiment of the present invention.

FIG. 3 is a schematic diagram of a temperature sensing device according to an embodiment of the present invention.

### DETAILED DESCRIPTION

The prior art temperature sensing device cannot cancel the effect of current path series resistors, therefore, the present invention provides a temperature sensing device, which can cancel the effect of current path series resistors and parasitic resistors according to a specific cycle for switching current sources for improving series resistor cancellation, so as to enhance the accuracy of temperature sensing.

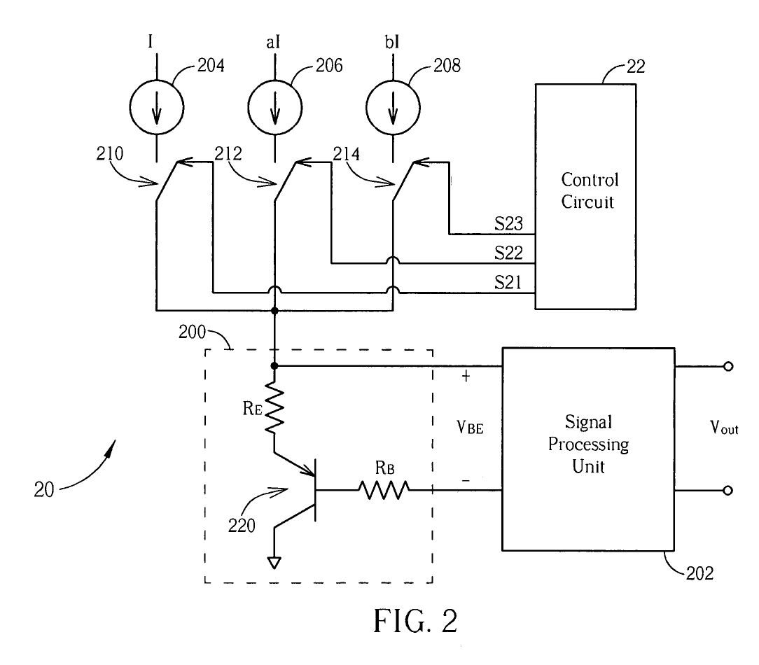

Please refer to FIG. 2. FIG. 2 is a schematic diagram of a temperature sensing device 20 according to an embodiment of the present invention. The temperature sensing device 20 comprises a temperature sensing unit 200, a signal processing unit 202, a first current source 204, a second current source 206, a third current source 208, a first switch 210, a second switch 212 and a third switch 214. The signal processing unit 202 is coupled to the temperature sensing unit 200. The first switch 210 is coupled between the current source 204 and the signal processing unit 202; the second switch 212 is coupled between the current source 206 and the signal processing unit 202; the third switch 214 is coupled between the current source 208 and the signal processing unit 202. On the other hand, the temperature sensing unit 200 comprises a temperature sensing component 220 and resistors R_{B} and R_{E}. In FIG. 2, the temperature sensing component 220 is a PNP bipolarjunction transistor (BJT), and the base of the temperature sensing component 220 is coupled to the resistor R_{B} and the emitter of the temperature sensing component 220 is coupled to the resistor R_{E}. The resistors R_{B} is a combination representation of a base parasitic resistor of the temperature sensing component 220 and a series resistor in the line forming the current path between the base of the temperature sensing component 220 and the signal processing unit 202. Similarly, the resistors R_{E} is a combination representation of an emitter parasitic resistor of the temperature sensing component 220 and a series resistor in the line forming the current path between the emitter of the temperature sensing component 220 and the signal processing unit 202.

The operation of the temperature sensing device 20 will be described in detail. The first switch 210 is used to control a signal connection between the first current source 204 and the signal processing unit 202 according to a first control signal S21; the second switch 212 is used to control a signal connection between the second current source 206 and the signal processing unit 202 according to a second control signal S22; the third switch 214 is used to control a signal connection between the third current source 208 and the signal processing unit 202 according to a third control signal S23. The first control signal S21, the second control signal S22 and the third control signal S23 are generated by a control circuit 22. In addition, let V_{BE1} be the voltage difference of the two terminals of the temperature sensing unit 200 when the first switch 210 is turned on and the first current source 204 drives the temperature sensing unit 200. Let V_{BE2} be the voltage difference of the two terminals of the temperature sensing unit 200 when the second switch 212 is turned on and the second current source 206 drives the temperature sensing unit 200. Similarly, let V_{BE3} be the voltage difference of the two terminals of the temperature sensing unit 200 when the third switch 214 is turned on and the third current source 208 drives the temperature sensing unit 200.

Note that, the control circuit 22 outputs the first control signal S21, the second control signal S22 and the third control signal S23 by a specific cycle, so as to respectively control the first switch 210, the second switch 212 and the third switch 214 for canceling the effect of series resistors. In an embodiment of the present invention, the effect of the resistors R_{B} and R_{E} is cancelled by a switch between the first current source 204 and the second current source 206 and a switch between the first current source 204 and the third current source 208. In other words, the specific cycle describes the output order formed by a switch between the first control signal S21 and the second control signal S22 and a switch between the first control signal S21 and the third control signal S23. In addition, ΔV_{BE} represents a difference between two voltage differences of the two terminals of the temperature sensing unit 200 at different currents. For example, when the current source that drives the temperature sensing unit 200 is switched from the first current source 204 to the second current source 206, ΔV_{BE21}=V_{BE2}−V_{BE1}, then, the signal processing unit 202 generates an output signal Vₒᵤₜ for presenting temperature variation according to ΔV_{BE}. Note that, the temperature sensing unit 200 is an exemplary embodiment of the present invention, and those skilled in the art can make alternations and modifications accordingly. In the present invention, the temperature sensing unit 200 can be any device that can generate ΔV_{BE} for the signal processing unit 202 for generating the output signal Vₒᵤₜ.

Let I, a×I and b×I be the currents of the first current source 204, the second current source 206 and the third current source 208 respectively. Let M be the number of switches between the first current source 204 and the second current source 206, and let N be the number of switches between the first current source 204 and the third current source 208, where a, b, M, N are positive integers; V_{T} is temperature equivalent voltage; Iₛ is a saturation current of the temperature sensing component 120; β is a characteristic parameter of the temperature sensing component 220; rₑ is the resistance of the resistor R_{E}; r_{b} is the resistance of the resistor R_{B}. According to the series resistor effect, V_{BE1}, V_{BE2}, V_{BE3}, ΔV_{BE21} and ΔV_{BE31} are given by the following equations:

V_{BE1}=V_{T}×In(I/Iₛ)+I×rₑ+/(β+1)×r_{b}

V_{BE2}=V_{T}×In(a×I/Iₛ)+a×I×rₑ+a×I/(β+1)×r_{b}

V_{BE3}=V_{T}×In(b×I/Iₛ)+b×I×rₑ+b×I/(β+1)×r_{b}

ΔV_{BE21}=V_{BE2}−V_{BE1}=V_{T}×In(a)+(a−1)×I×(rₑ+(1/(β+1)×r_{b})

ΔV_{BE31}=V_{BE3}−V_{BE1}=V_{T}×In(b)+(b−1)×I×(rₑ+(1/(β+1)×r_{b})

M×ΔV_{BE21}−N×ΔV_{BE31}=M×V_{T}×In(a)−N×V_{T}×In(b)+M×(a−1)×I×(rₑ+(1/(β+1)×r_{b})−N×(b−1)×I×(rₑ+(1/(β+1)×r_{b}) (2)

From the equation (2), it is known that the series resistor effect can be cancelled when M×(a−1)=N×(b−1), that is, M×ΔV_{BE21}−N×ΔV_{BE31}=V_{T}×In[a^{M}/b^{N}]. For example, let a=10, b=19, M=2 and N=1, the equation (2) becomes:

2×ΔV_{BE21}−ΔV_{BE31}=V_{T}×In[10²/19¹]=V_{T}×In(5.26)

or let a=6, b=16, M=3 and N=1, the equation (2) becomes:

3×ΔV_{BE21}−ΔV_{BE31}=V_{T}×In[6³/16¹]=V_{T}×In(13.5)

If M=2 and N=1, the turning-on order of the current sources is formed by the first current source 204, the second current source 206, the first current source 204 and the third current source 208 in order. In other words, the control circuit 22 outputs control signals by the specific cycle formed by the first control signal S21, the second control signal S22, the first control signal S21 and the third control signal S23 in order. Similarly, if M=3 and N=1, the turning-on order of the current sources is the second current source 206, the first current source 204, the second current source 206, the first current source 204 and the third current source 208 in order. In other words, the control circuit 22 outputs control signals by the specific cycle formed by the second control signal S22, the first control signal S21, the second control signal S22, the first control signal S21 and the third control signal S23 in order.

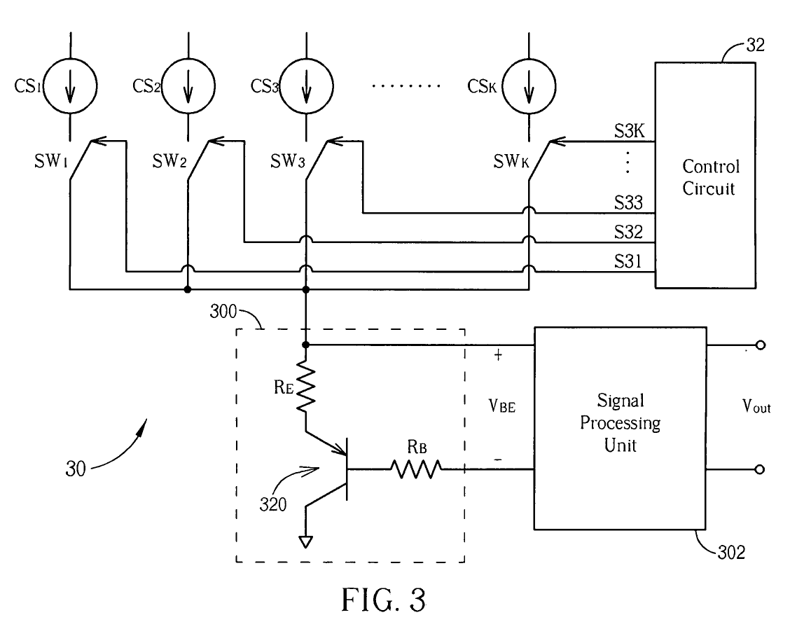

Note that, the temperature sensing device 20 is an embodiment of the present invention, and those skilled in the art can make alternations and modifications accordingly. Please refer to FIG. 3. FIG. 3 is a schematic diagram of a temperature sensing device 30 according to an embodiment of the present invention. The temperature sensing device 30 is similar to the temperature sensing device 20. The difference is that the temperature sensing device 20 comprises 3 current sources and 3 switches, while the temperature sensing device 30 comprises K current sources and K switches for K≧3. The temperature sensing device 30 comprises a temperature sensing unit 300, a signal processing unit 302, K current sources CS₁-CSₖ and K switches SW₁-SWₖ. The temperature sensing unit 300 comprises a temperature sensing component 320 and resistors R_{B} and R_{E}. The operation and the relationships of each unit of the temperature sensing device 30 is similar to the temperature sensing device 20 and is not given here. In addition, a control circuit 32 generates K control signals S31-S3k. Each control signal of the K control signals controls a signal connection between one corresponding current source of the K current sources and the signal processing unit 302. Let a₁×I, a₂×I, a₃×I, . . . , aₖ×I be the currents of the K current sources CS₁-CSₖ respectively. According to the series resistor effect, the voltage difference of the two terminals of the temperature sensing unit 300 at different current are given by the following equations:

V_{BE1}=V_{T}×In(a₁×I/Iₛ)+a₁×I×rₑ+a₁×I/(β+1) ×r_{b}

V_{BE2}=V_{T}×In(a₂×I/Iₛ)+a₂×I×rₑ+a₂×I/(β+1) ×r_{b}

V_{BE3}=V_{T}×In(a₃×I/Iₛ)+a₃×I×rₑ+a₃×I/(β+1) ×r_{b}

. . .

V_{BEk}=V_{T}×In(aₖ×I/Iₛ)+aₖ×I×rₑ+aₖ×I/(β+1) ×r_{b}

In order to cancel the effect of the series resistor effect, the present invention lets aₖ=(a₁+a₂+a₃+ . . . +aₖ₋₁)/(k−1) and then generates the following equation for a specific cycle:

$$( k - 1 ) \times {V}_{BEk} - {V}_{BE 1} - {V}_{BE 2} - {V}_{BE 3} - … - {V}_{BE ( k - 1 )} = ( {V}_{BEk} - {V}_{BE 1} ) + ( {V}_{BEk} - {V}_{BE 2} ) + … + ( {V}_{BEk} - {V}_{BE ( k - 1 )} ) = Δ {V}_{BEk 1} + Δ {V}_{BEk 2} + Δ {V}_{BEk 3} + … + Δ {V}_{BEk ( k - 1 )} = {V}_{T} \times ln [ ( {a}_{k} / {a}_{1} ) \times ( {a}_{k} / {a}_{2} ) \times … \times ( {a}_{k} / {a}_{k - 1} ) ] = {V}_{T} \times ln [ {( {a}_{1} + {a}_{2} + … + {a}_{k - 1} )}^{( k - 1 )} \times ( 1 / ( ( {a}_{1} \times {a}_{2} \times … \times {a}_{k - 1} ) \times {( k - 1 )}^{( k - 1 )} ) ) , k ≧ 3 \qquad ( 3 )$$

From the equation (3), it is known that the turning-on order of the K current sources is formed by CS₁, CSₖ, CS₂, CSₖ, CS₃, CSₖ, . . . , CSₖ₋₁, CSₖ. Therefore, the embodiment of the present invention obtains a regular turning-on order of the current sources. For example, suppose the temperature sensing device 30 comprises 4 current sources CS₁-CS₄. Let a₁×I, a₂×I, a₃×I and a₄×I are currents of the 4 current source respectively, and let a₄=(a₁+a₂+a₃)/3, therefore, the regular turning-on order of the 4 current sources is CS₁, CS₄, CS₂, CS₄, CS₃, CS₄, that forms the specific cycle. Note that, the switches of different current sources are controlled by the K control signals S31-S3k generated by the control circuit 32. As to the implementation of the control circuit 32, it is easier to implement the regular turning-on order, and as a result, the production cost of the embodiment of the present invention is reduced.

In conclusion, the embodiment of the present invention can preferably cancels the effect of current path series resistors and parasitic resistors. Consequently, the location of temperature sensing component in the temperature sensing device is more flexible, and the production cost is reduced.

Those skilled in the art will readily observe that numerous modifications and alterations of the device and method may be made while retaining the teachings of the invention.

What is claimed is:

1. A temperature sensing device for improving series resistance cancellation mechanism comprising:
a temperature sensing unit comprising a first terminal and a second terminal for generating a plurality of voltage signals;
a signal processing unit coupled to the temperature sensing unit for performing a signal process on the plurality of voltage signals for generating an output signal for presenting temperature variation;
a first current source for driving the temperature sensing unit;
a second current source for driving the temperature sensing unit;
a third current source for driving the temperature sensing unit;
a first switch coupled between the first current source and the first terminal of the temperature sensing unit for controlling a signal connection between the first current source and the first terminal of the temperature sensing unit according to a first control signal;
a second switch coupled between the second current source and the first terminal of the temperature sensing unit for controlling a signal connection between the second current source and the first terminal of the temperature sensing unit according to a second control signal; and
a third switch coupled between the third current source and the first terminal of the temperature sensing unit for controlling a signal connection between the third current source and the first terminal of the temperature sensing unit according to a third control signal;
wherein the first control signal, the second control signal and the third control signal are generated by a control circuit and are outputted from the control circuit according to a specific cycle formed by a plurality of switches between the first control signal and the second control signal and one switch between the first control signal and the third control signal.

2. The temperature sensing device of claim 1, wherein the specific cycle is utilized for canceling the effect of an intrinsic resistor of the temperature sensing unit.

3. The temperature sensing device of claim 1, wherein the specific cycle is utilized for canceling the effect of a current path series resistor between the first terminal of the temperature sensing unit and the signal processing unit.

4. The temperature sensing device of claim 1, wherein the specific cycle is utilized for canceling the effect of a current path series resistor between the second terminal of the temperature sensing unit and the signal processing unit.

5. A temperature sensing device for improving series resistance cancellation mechanism comprising:
a temperature sensing unit comprising a first terminal and a second terminal for generating a plurality of voltage signals;
a signal processing unit coupled to the temperature sensing unit for performing a signal process on the plurality of voltage signals for generating an output signal for presenting temperature variation;
a plurality of current sources for driving the temperature sensing unit; and
a plurality of switches, each of the plurality of switches being coupled between a corresponding current source of the plurality of current sources and the first terminal of the temperature sensing unit for controlling a signal connection between the corresponding current source of the plurality of current sources and the first terminal of the temperature sensing unit according to one of a plurality of control signals;
wherein a number N of the plurality of current sources is greater than or equal to 3 and the plurality of control signals are generated by a control circuit and are outputted from the control circuit according to a specific cycle formed by an output order of a first control signal, a Nth control signal, a second control signal, the Nth control signal, a third control signal, the Nth control signal, . . . , a (N−1)th control signal and the Nth control signal.

6. The temperature sensing device of claim 5, wherein the specific cycle is utilized for canceling the effect of an intrinsic resistor of the temperature sensing unit.

7. The temperature sensing device of claim 5, wherein the specific cycle is utilized for canceling the effect of a current path series resistor between the first terminal of the temperature sensing unit and the signal processing unit.

8. The temperature sensing device of claim 5, wherein the specific cycle is utilized for canceling the effect of a current path series resistor between the second terminal of the temperature sensing unit and the signal processing unit.
